(19) United States
(12) Patent Application Publication
(10) Pub. No.: US 2026/0141048 A1
(43) Pub. Date: May 21, 2026

(54) DETECTION OF AUTOMATED COMPUTING AGENTS FOR BYPASSING ELECTRONIC VERIFICATION

(71) Applicant: AMADEUS S.A.S., Biot (FR)

(72) Inventors: Elisa CHIAPPONI, Antibes (FR); Umberto FONTANA, Nice (FR); Gerardo REYNAGA, Nice (FR); Claudio COSTANZA, Menton (FR); Martynas BUOZIS, Erding (FR); Mohamed FANGAR, Nice (FR); Vincent RIGAL, Antibes (FR); Herve DEBAR, Palaiseau (FR)

(21) Appl. No.: 19/390,333

(22) Filed: Nov. 14, 2025

Related U.S. Application Data
(60) Provisional application No. 63/722,496, filed on Nov. 19, 2024.

(51) Int. Cl. G06F 21/45; G06F 21/36

(52) U.S. Cl. CPC G06F 21/45; G06F 21/36; G06F 2221/2133

(57) ABSTRACT

The present specification describes a various novel systems, apparatuses, and methods for detecting automated computing agents that attempt to bypass electronic verification systems, such as CAPTCHA. The system employs a bypass detection engine to analyze timing data, including propagation times, between a requesting node and verification systems. By comparing these timings against expected ranges, the system can identify anomalies indicative of automated behaviour. The detection engine can adjust for factors like VPN usage and utilize machine learning models, such as isolation forest algorithms.

### CROSS REFERENCE TO RELATED APPLICATIONS

This application claims priority from U.S. Provisional patent application No. 63/722,496, filed Nov. 19, 2024, the contents of which is incorporated herein by reference.

### FIELD

The present specification relates generally to systems and methods for detecting unauthorized automated processes in electronic environments. More specifically, it pertains to identifying and mitigating automated computing agents that attempt to bypass electronic verification systems.

### BACKGROUND

When websites implement electronic verification systems, such as CAPTCHAs, they aim to verify that interactions originate from legitimate users rather than automated bots. A growing challenge to these systems is the use of CAPTCHA-solving methods that can bypass verification by exploiting human CAPTCHA farms or advanced automated solvers. CAPTCHA farms use human labor to solve CAPTCHAs on behalf of bots, while automated solvers leverage machine learning to mimic human responses. These developments present a technical challenge for accurately distinguishing between valid users and deceptive automated agents.

### SUMMARY

An aspect of the specification provides a computer-implemented method for detecting automated computing agents attempting to bypass an electronic verification system, the method including instructions executed by a bypass detection engine, including: receiving, at the bypass detection engine, timing data associated with communication between a requesting node and at least one of a content delivery engine and an electronic verification engine; determining, at the bypass detection engine, an expected range for the timing data based on at least one of the geographic locations of the requesting node, the content delivery engine, and the electronic verification engine; comparing the timing data with the determined range; identifying an anomaly if the timing data is outside the expected range; and flagging the requesting node as an automated computing agent based on identification of the anomaly; and, otherwise, flagging the requesting node as a client device.

An aspect of the specification provides that the electronic verification engine hosts a Completely Automated Public Turing test to tell Computers and Humans Apart (CAPTCHA), and the automated computing agent is an automated solver for CAPTCHAs.

An aspect of the specification provides that the timing data includes a site key propagation time, measured between the transmission of a site key from the content delivery engine to the requesting node, the transmission of the same key to the electronic verification engine, and the receipt of a signal by the electronic verification engine indicating an attempt by the requesting node to interact with the electronic verification system.

An aspect of the specification provides that the timing data further includes a token propagation time, measured between the transmission of a token from the electronic verification engine to the requesting node and the receipt of the token by the content delivery engine from the requesting node.

An aspect of the specification provides for identifying whether the requesting node is utilizing a Virtual Private Network (VPN) based on network data associated with the requesting node and adjusting the expected range for the timing data based on the identification of VPN usage.

An aspect of the specification provides that determining the expected range for the timing data includes retrieving statistical information on average propagation times based on the geographic locations of the requesting node, the content delivery engine, and the electronic verification engine.

An aspect of the specification provides that determining the expected range for the timing data includes applying extreme value theory to identify outliers in the observed timing data, setting the range based on peaks over threshold analysis.

An aspect of the specification provides for detecting anomalies in the timing data by utilizing a machine learning model trained on historical timing data, wherein the model identifies timing anomalies indicative of automated computing agents.

An aspect of the specification provides that the machine learning model includes an isolation forest algorithm configured to identify anomalies by isolating potential automated computing agent behavior from normal requesting node behavior.

An aspect of the specification provides that determining the expected range for the timing data includes calculating the range using delay-based IP geolocation techniques to estimate geographic distances based on network delay measurements.

An aspect of the specification provides for adjusting the expected range for the timing data based on historical network performance data for the geographic region of the requesting node.

An aspect of the specification provides that identifying an anomaly includes comparing both the site key propagation time and the token propagation time to determine the more reliable measurement, selecting the shorter of the two times, and using this selected time to compare against a threshold value calculated based on geolocation, machine learning models, or other techniques to identify an anomaly.

An aspect of the specification provides for synchronizing the clocks of the electronic verification engine and the content delivery engine to ensure accuracy in the timing data measurements.

An aspect of the specification provides a computer-implemented method for detecting automated computing agents for bypassing an electronic verification system, the method including instructions executed by one or more processors, including: receiving, from a user device, a request to access a website; transmitting a site key and a CAPTCHA challenge from the website to the user device; receiving, at a CAPTCHA server, a response from the user device to the CAPTCHA challenge; measuring a propagation time associated with the communication between the user device and the CAPTCHA service; determining an expected threshold for the propagation time based on at least one of the geographic locations of the user device, the website server, and the CAPTCHA server; comparing the measured propagation time with the determined threshold; identifying an anomaly in the propagation time if the measured propagation time exceeds the expected threshold; and, based on the identification of the anomaly, flagging the user device as being connected to a potential CAPTCHA solver.

An aspect of the specification provides that the automated solver is an automated solver for a Completely Automated Public Turing test to tell Computers and Humans Apart (CAPTCHA).

An aspect of the specification provides that measuring the propagation time includes measuring a site key propagation time between the transmission of the site key from the user device to the CAPTCHA service and the receipt of a signal by the CAPTCHA service indicating the user device's attempt to solve the CAPTCHA challenge.

An aspect of the specification provides that measuring the propagation time includes measuring a token propagation time between the transmission of the CAPTCHA token from the CAPTCHA service to the user device and the receipt of the token by the website server from the user device.

An aspect of the specification provides for identifying whether the user device is utilizing a Virtual Private Network (VPN) based on the network data associated with the user device and adjusting the expected threshold for the propagation time based on the identification of VPN usage.

An aspect of the specification provides that determining the expected threshold for the propagation time includes retrieving statistical information on average propagation times based on the geographic locations of the user device, the website server, and the CAPTCHA server.

An aspect of the specification provides that determining the expected threshold for the propagation time includes applying extreme value theory to identify outliers in the observed propagation times to set a threshold based on peaks over threshold analysis.

An aspect of the specification provides for detecting abnormal propagation times by utilizing a machine learning model trained on historical propagation time data, wherein the model identifies anomalies indicating the use of CAPTCHA solvers.

An aspect of the specification provides that the machine learning model includes an isolation forest algorithm configured to identify anomalies by isolating potential CAPTCHA solver behavior from normal user behavior.

An aspect of the specification provides that determining the expected threshold for the propagation time includes calculating the threshold using delay-based IP geolocation techniques that estimate geographic distances based on network delay measurements.

An aspect of the specification provides for adjusting the expected threshold for propagation time based on historical network performance data for the geographic region of the user device.

An aspect of the specification provides that identifying an anomaly includes comparing both the site key propagation time and the token propagation time, and using the smaller of the two times to determine the anomaly.

An aspect of the specification provides the timing data comprising a site key propagation time for a first request and only a token propagation time for one or more subsequent requests, wherein the identifying of the anomaly further includes identifying the anomaly when the site key propagation time is absent for the subsequent requests.

An aspect of the specification provides the identifying of the anomaly further comprising identifying the anomaly when a site key propagation time is negative.

An aspect of the specification provides for synchronizing the clocks of the CAPTCHA server and the website server to ensure accuracy in the propagation time measurements.

The present specification also contemplates methods, systems, apparatuses and computer readable media according to any of the foregoing.

### BRIEF DESCRIPTION OF THE FIGURES

The present specification includes the attached Figures, in which:

FIG. 1 shows a system for detection of automated computing agents for bypassing electronic verification.

FIG. 2 shows a schematic diagram of a non-limiting example of internal components of the detection engine of FIG. 1.

FIG. 3 shows a schematic diagram of a non-limiting example of a stack of components associated with the engine of FIG. 2.

FIG. 4 shows a flowchart depicting a method for detection of automated computing agents for bypassing electronic verification.

FIG. 5 shows a variant on the system of FIG. 1 focusing on user interaction.

FIG. 6 shows a variant on the system of FIG. 1 focusing on bot interaction including the use of solver processes

FIG. 7 shows a variant on the system of FIG. 1 focusing on bot interaction omitting the use of solver processes.

### DETAILED DESCRIPTION

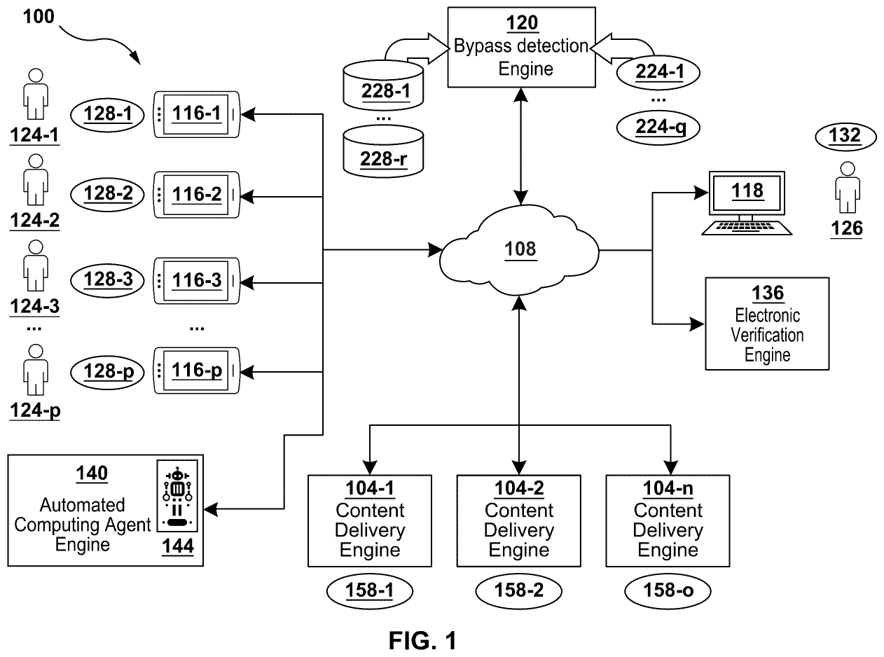

FIG. 1 shows a system detection of automated computing agents for bypassing electronic verification indicated generally at 100. System 100 comprises a plurality of content delivery engines 104-1, 104-2 . . . 104-n. (Collectively, engines 104-1, 104-2 . . . 104-n are referred to as engines 104, and generically, as engine 104. This nomenclature is used elsewhere herein.) In system 100, engines 104 connect to a network 108 such as the Internet. Network 108 interconnects content delivery engines 104 with a plurality of client devices 116, at least one administrator terminal 118, a bypass detection engine 120, an electronic verification engine 136 and at least one automated computing agent engine 140.

Each client device 116-1, 116-2, 116-3 corresponds to a respective different user 124, with an identifier object 128 associating each user 124 with its respective device 116.

Management terminal 118 corresponds to a system administrator 126. An identifier object 132 associates administrator 126 with management terminal 118.

Automated computing agent engine 140 executes a bot 144 that is configured to simulate a user 124 as engine 140 interacts with content delivery engines 104. Automated computing agent engine 140 is configured to attempt to bypass the electronic verification engine 136 and obtain access to one or more content delivery engines 104 by simulating behaviour of a user 124 accessing a respective client device 116. (While only a single engine 140 with a single associated bot 144 is depicted in FIG. 1, other embodiments may include multiple engines 140, each with one or more associated bots 144, collectively forming a “bot farm”. Alternatively, one single automated computing agent engine 140 can execute a plurality of bots 144. Thus, in variants, automated computing agent engine 140 can also be construed as “bot farm”.) To elaborate, electronic verification engine 136 is configured to respond to access requests of engines 104 by requiring electronic verification before access to content delivery engines 104 is granted. Such electronic verification can include challenge-response tests or other forms of electronic verification to distinguish between users 124 of devices 116 and automated computing agent 140.

In a presently preferred embodiment, electronic verification engine 136 is configured to generate challenge-response tests including evaluating responses. In a presently preferred embodiment, a contemplated challenge-response test is a Completely Automated Public Turing test to tell Computers and Humans Apart (“CAPTCHA”) tests. However, equivalents to CAPTCHA are contemplated, such as a reCAPTCHA or Invisible reCAPTCHA. Electronic verification engine 136 ensures that access to content delivery engines 104 is from a user 124 vs an automated bot 144 executing on the automated computing agent engine 140. As will be explained in greater detail below, the electronic verification engine 136 operates in conjunction with bypass detection engine 120 to monitor response times and behaviors interactions with verification mechanisms of electronic verification engine 136. (Note that in variants, bypass detection engine 120 can be incorporated directly into each content delivery engines 104)

The bypass detection engine 120 continuously measures various propagation times between: a) content delivery engines 104 and electronic verification engine 136, with signals passing through client devices 116; and, b) content delivery engines 104 and electronic verification engine 136, with signals passing through automated computing agent engine 140 executing bot 144. As will be discussed in greater detail below, by analyzing these propagation times as they pass through the client device 116 or automated computing agent engine 140, bypass detection engine 120 can determine whether the interaction originates from an authentic user 124 or an automated bot 144.

The bypass detection engine 120 is further equipped with databases 228-1 and 228-r, which store historical data and predefined thresholds for propagation times based on geographical locations of client devices 116, content delivery engines 104, and electronic verification engines 136. This historical data allows bypass detection engine 120 to compare measured propagation times against expected values, accounting for factors such as network congestion or virtual private network (VPN) usage.

Electronic verification engine 136 can also be further configured to synchronize clocks with content delivery engines 104 and bypass detection engine 120, ensuring accurate timing for propagation measurements. This synchronization is necessary to accurately identify any anomalies in the communication between client devices 116 and the electronic verification engines 136.

In the event that an anomaly in the propagation time is detected, bypass detection engine 120 can flag the interaction as suspicious. The flagged interaction can then be further analyzed by system administrator 126 via management terminal 118, or it can automatically trigger additional verification challenges to the client device 116, or automated computing agent engine 140, or the flagged interaction can simply deny further communications with the relevant content delivery engine 104, as desired or appropriate.

Bypass detection engine 120 can be scalable and/or distributed across different geographic locations or data centers, for redundancy and system performance enhancement for global operations.

Content delivery engines 104 can be based on any present or future electronic servers or computing architectures that, among other things, host websites. Each content delivery engine 104 processes and delivers requested content to client devices 116. This process can involve steps such as content caching, load balancing, and compression to optimize delivery efficiency. In some embodiments, content delivery engines 104 can retrieve dynamic content from external databases or content management systems (CMS) in response to user interactions. Additionally, these engines can interact with third-party APIs or cloud services to extend functionality, such as offloading certain processing tasks like image rendering or video streaming.

Content delivery engines 104 can handle different types of data, including static web pages, dynamic scripts (e.g., JavaScript or PHP), multimedia files, and real-time data streams. This requires sufficient networking and storage capabilities to manage traffic without significantly impacting the user experience.

In distributed or cloud-based configurations, content delivery engines 104 can operate across multiple data centers or regions, employing content delivery network (CDN) techniques to reduce latency and manage content routing. They can also integrate with external load balancers and caching systems to distribute content to users 124 in various geographic locations. Depending on the deployment, content delivery engines 104 can function as stateless or stateful components, potentially synchronizing with other engines to ensure consistent content delivery across the system. In general, content delivery engines 104 are capable of managing varying types and volumes of content requests from users 124, ensuring that content is delivered in accordance with system requirements.

Bypass detection engine 120 can be any type of electronic server or computing architecture that monitors communications between client devices 116, automated computing agent engine 140, content delivery engines 104 and electronic verification engine 136, as discussed in greater detail elsewhere.

Client devices 116 can be any type of human-machine interface for interacting with bypass detection engine 120. For example, client devices 116 can include traditional laptop computers, desktop computers, mobile phones, tablet computers and any other device that can be used to receive and send content that complement the input and output hardware devices associated with a given client device 116. It is contemplated client devices 116 can include virtual or augmented reality gear complementary to virtual reality or augmented reality or “metaverse” environments that can be offered on collaboration engines 104. Client devices 116 can be operated by different users 124 that are associated with a respective identifier object 128 that uniquely identifies a given user 124 accessing a given client device 116 in system 100.

Accordingly, client devices 116 are based on any suitable client computing platform operated by users 124 that can have an interest in the content being provided by engines 104. Each device 116 and its user 124 is thus typically associated with a user identifier object 128, particularly if any booking functions are to be utilized.

A person of skill in the art is to recognize that the form of an identifier object 128 is not particularly limited, and in a simple example embodiment, can be simply an alpha-numerical sequence that is entirely unique in relation to other identifier objects in system 100. Identifier objects can also be more complex as they can be combinations of account credentials (e.g. username, password, Two-factor authentication token, etc.) that uniquely identify a given user 124. Identifier objects themselves can also be indexes that point to other identifier objects, such as one or more accounts. The salient point is that they are uniquely identifiable within system 100 in association with what they represent. Identifier objects 128 can include profiles and other demographic information associated with its respective users 124 which can be used as part of a transaction message orchestration.

Administrator terminal 118 can also be any type of human-machine interface of the same type as client devices 116. Administrator terminal 118 is operated by an administrator 126. In the present embodiment, there is one administrator terminal 118 for bypass detection engine 120. It is to be understood that administrator terminal 118 is optional and can be omitted in other embodiments.

Administrator 126 can operate administrator terminal 118 to monitor and manage the operation and configuration of the bypass detection engine 120. Administrator terminal 118 allows administrator 126 to access various system metrics, including historical data, real-time communication analysis, and flagged anomalies identified by bypass detection engine 120. In the event of suspicious activity or an anomaly in the propagation time, administrator 126 can intervene to further investigate, initiate additional verification challenges, or manually deny access to certain client devices 116 or automated computing agents 140 attempting to bypass the electronic verification engine 136. Administrator terminal 118 can also be used to adjust system parameters, such as updating predefined thresholds or ranges stored in databases 228-1 and 228-r or managing the synchronization settings for content delivery engines 104, bypass detection engine 120, and electronic verification engine 136. Furthermore, administrator terminal 118 can provide an interface for logging system events, generating reports, and issuing alerts to the system administrator 126, ensuring that potential threats to the system are mitigated in a timely and efficient manner.

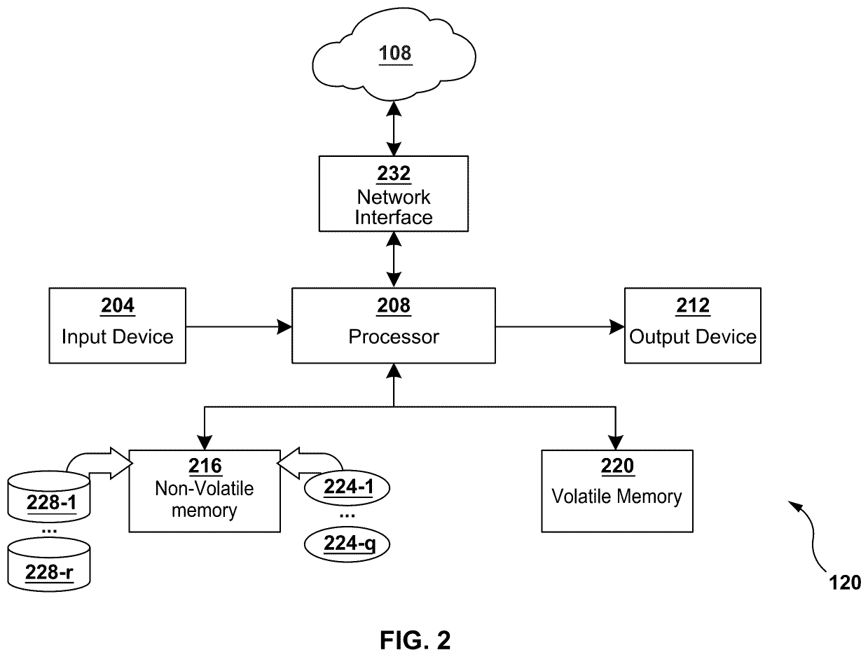

Having described an overview of system 100, it is useful to comment on the hardware infrastructure of system 100. FIG. 2 shows a schematic diagram of a non-limiting example of internal components of bypass detection engine 120.

In this example, bypass detection engine 120 includes at least one input device 204. Input from device 204 is received at a processor 208 which in turn controls an output device 212. Input device 204 can be a traditional keyboard and/or mouse to provide physical input. Likewise output device 212 can be a display. In variants, additional and/or other input devices 204 or output devices 212 are contemplated or can be omitted altogether as the context requires.

Processor 208 can be implemented as a plurality of processors or one or more multi-core processors. The processor 208 can be configured to execute different programming instructions responsive to the input received via the one or more input devices 204 and to control one or more output devices 212 to generate output on those devices.

To fulfill its programming functions, the processor 208 is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. Non-volatile memory 216 can also be described as a non-transitory computer readable media. Non-volatile memory 216 can be used as a cache for caching. Also, more than one type of non-volatile memory 216 can be provided.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated. Volatile memory 220 can also be used as a cache for caching.

Processor 208 also connects to network 108 via a network interface 232. Network interface 232 can also be used to connect another computing device that has an input and output device, thereby obviating the need for input device 204 and/or output device 212 altogether.

Programming instructions in the form of applications 224 are typically maintained, persistently, in non-volatile memory 216 and used by the processor 208 which reads from and writes to volatile memory 220 during the execution of applications 224. Various methods discussed herein can be coded as one or more applications 224. One or more tables or databases 228 are maintained in non-volatile memory 216 for use by applications 224.

The infrastructure of bypass detection engine 120, or a variant thereon, can be used to implement any of the computing nodes in system 100, including content delivery engines 104, bypass detection engine 120 and electronic verification engines 136. In variants, bypass detection engine 120 can be incorporated directly into one or more content delivery engines 104, resulting in one or more bypass detection engines 120 respective to various content delivery engines 104, where each bypass detection engine 120 is configured to orchestrate transaction messages between electronic verification engine 136 and its respective content delivery engines 104.

By the same token, a plurality of bypass detection engines 120 independent from content delivery engines 104 can be provided. Overall, the engines 104 and/or engine 120 and/or electronic verification engine 136 and other nodes in system 100 can be implemented using cloud computing platforms such as Microsoft Azure™ or Amazon Web Services (AWS)™.

Furthermore, one or more of the engine nodes in system 100 (e.g. bypass detection engine 120, content delivery engines 104, electronic verification engines 136) can also be implemented as virtual machines and/or with mirror images to provide load balancing.

A person of skill in the art will recognize that the core elements of processor 208, input device 204, output device 212, non-volatile memory 216, volatile memory 220 and network interface 232, as described in relation to the server environment of bypass detection engine 120, have analogues in the different form factors of client machines such as those that can be used to implement client devices 116 and administrator terminal 118. Again, client devices 116 can be based on computer workstations, laptop computers, tablet computers, mobile telephony devices or the like.

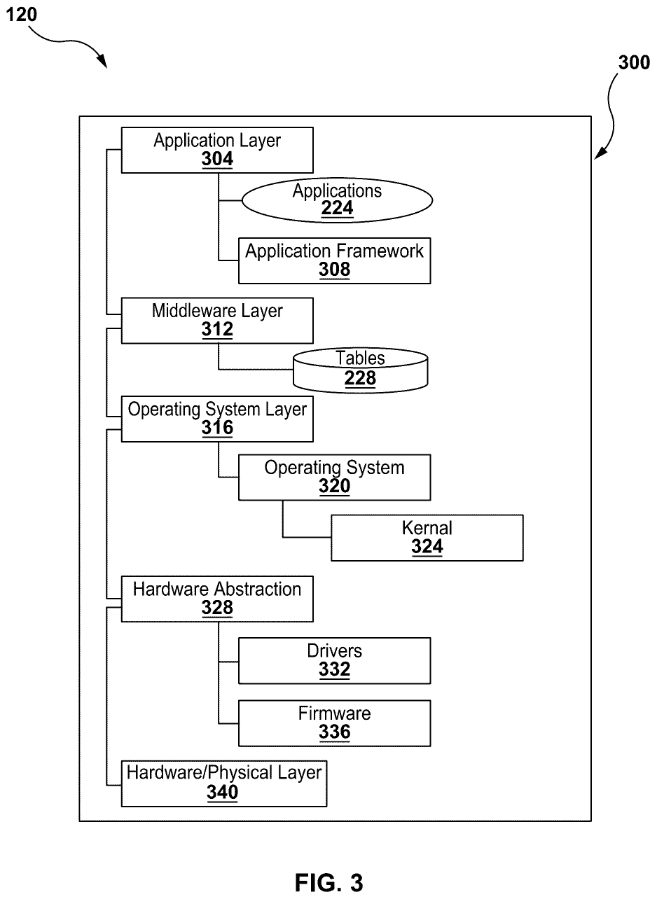

FIG. 3 provides another schematic representation of bypass detection engine 120, including detailed view of a stack 300 employed in the computing environment of bypass detection engine 120. The stack 300 is structured to depict the different layers involved in the operation bypass detection engine 120, from the application layer 304 down to the physical hardware layer 340 of bypass detection engine 120.

At the highest level, the application layer 304 encompasses the various applications 224 and application frameworks 308. Applications 224 represent the end-user software programs such as web browsers, email clients, and office suites that perform specific tasks. Application frameworks 308 include the libraries and frameworks that facilitate application development, such as .NET, Spring, and Django.

Beneath the application layer is the middleware layer 312, which includes tables 228 and other middleware components. Middleware serves as an intermediary that provides common services and capabilities to applications outside of what the operating system offers. Examples include database management systems, web servers (e.g., Apache, Nginx), and application servers (e.g., Tomcat).

The operating system layer 316 is composed of the operating system 320 and kernel 324. The operating system 320 is the system software that manages hardware resources and provides essential services to computer programs. The kernel 324 is the core part of the operating system, responsible for managing system resources and facilitating communication between hardware and software components.

The hardware abstraction layer 328 includes drivers 332 and firmware 336. Drivers 332 are software components that enable the operating system 320 and other software to communicate with hardware devices shown in FIG. 2. Examples include device drivers for input device 204, output device 212 and network interface 232. Firmware 336 can software programmed into hardware devices of physical hardware layer 340 to provide low-level control and communication.

At the base of the stack is the hardware and physical layer of bypass detection engine 120, encompassing the physical hardware components such as the input device 204, processor 208, non-volatile memory 216, volatile memory 220 and network interface 232.

Stack 300 illustrates how different layers interact within a computing environment of bypass detection engine 120, enabling the execution of various applications 228 and services such as applications 224. Each layer can interact with the layer below it to function correctly, and together they form a cohesive system that powers the computing capabilities of devices such as those used in the bypass detection engine 120, content delivery engines 104, client devices 116 and other nodes of system 100.

The stack 300 in FIG. 3 can be applied to various computing environments including other hardware nodes in system 100, including server infrastructures for engines 104, bypass detection engine 120 and electronic verification engine 136 as well as client devices 116 and administrator terminal 118. Whether implemented in a traditional server environment or as virtual machines on cloud computing platforms like Microsoft Azure or Amazon Web Services (AWS), the described layers of stack 300 provide a framework for managing and executing software applications such as applications 224 and middleware layers 312 such as databases 228.

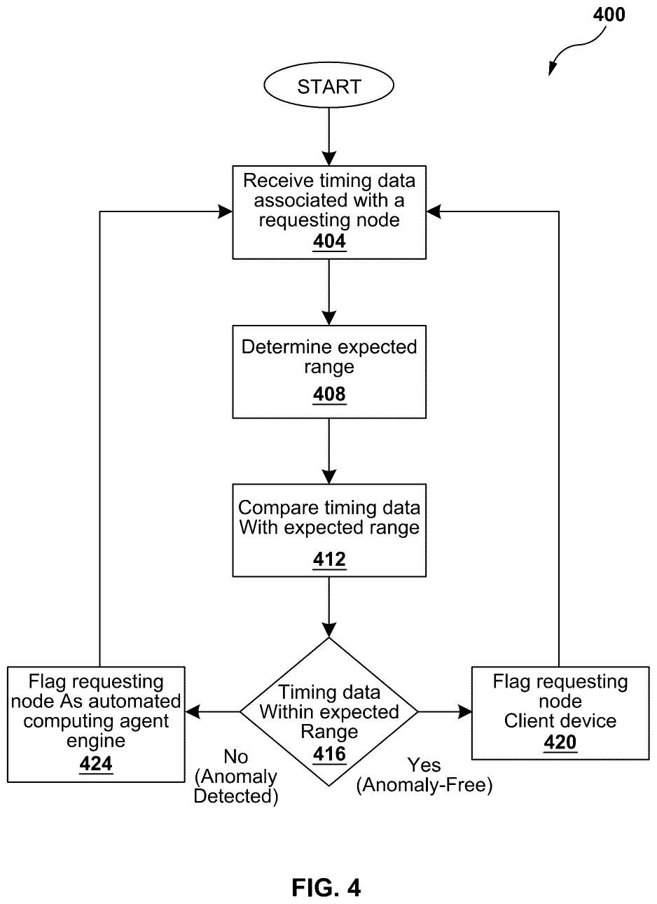

FIG. 4 shows a flowchart depicting a method for transaction message orchestration indicated generally at 400. Method 400 can be implemented on system 100. Persons skilled in the art can choose to implement method 400 on system 100 or variants thereon, or with certain blocks omitted, performed in parallel or in a different order than shown. Method 400 can thus also be varied. However, for purposes of explanation, method 400 will be described in relation to its performance on system 100 with a specific focus on treating method 400 as, for example, application 224-1 maintained within bypass detection engine 120 and its interactions with the other nodes in system 100.

Block 404 comprises receiving, at bypass detection engine 120, timing data associated with a requesting node (e.g., one of the client devices 116 or automated computing agent engine 140). The timing data can be associated with interactions between the requesting node and one or more other nodes in system 100, such as content delivery engines 104 or electronic verification engine 136. The timing data can be retrieved from one or more databases 228-1 and 228-r or from real-time network monitoring. Block 404 collects the data to determine if there are anomalies in the communication between the nodes in the system.

Block 408 comprises determining, at bypass detection engine 120, an expected range for the timing data based on at least one of the geographic locations of the requesting node, content delivery engines 104, and electronic verification engine 136. This determination can involve comparing the received timing data with historical timing data stored in databases 228, adjusting for known network conditions, such as VPN usage, and taking into account the relative locations of the nodes involved. The expected range for timing data can be dynamic, changing based on these contextual factors, and may also incorporate statistical or machine learning models, as discussed elsewhere in this specification.

The geolocation data itself can be collected in various ways. In one non-limiting example embodiment, the bypass detection engine 120 can be configured to receive real-world connection data from “volunteer” servers in various global locations over different days and times across network 108. This data can capture latencies in network 108 between, for example, a content delivery engine 104, a client device 116, and the CAPTCHA service at electronic verification engine 136, allowing segmentation of historical latency data by geographic region to create tailored timing ranges for each location. For untested locations, the engine 120 can be configured to estimate thresholds by interpolating data from the nearest tested regions.

Additionally, the bypass detection engine 120 can be configured to integrate external network condition databases, such RIPE ATLAS (https://atlas.ripe.net/measurements/public?sort=-id&id_gt=1000000&toggle=all&page_size=100&page=1) and CloudFlare Radar (https://radar.cloudflare.com/), to account for real-time latency issues in specific regions. When such issues are identified, the engine 120 can mark measurements as unreliable and suspend anomaly detection temporarily for those regions. This combination of tailored thresholding and dynamic adjustments ensures robust and accurate detection of anomalies across diverse environments of network 108.

Block 412 comprises comparing the received timing data with the expected range, as determined in block 408. This comparison allows bypass detection engine 120 to identify any discrepancies between the actual data received from the requesting node and what would be considered normal for the given context. Any significant deviations from the expected range are noted as potential anomalies.

Block 416 comprises determining whether the timing data falls within the expected range. If the data falls within the expected range, it is deemed consistent with normal communication patterns in the system, in which case a “Yes” determination is made at block 416 and method 400 advances to block 420. If the timing data falls outside the expected range, bypass detection engine 120 identifies this as a potential anomaly, in which case a “No” determination is reached at block 416 and method 400 advances to block 424.

To elaborate, block 420 comprises flagging the requesting node as “anomaly-free”, and that as originating from a client devices 116 based on the results of the determination made in block 416. On the other hand, block 424 comprises flagging the requested note as anomalous, and the requesting node is flagged as potentially associated with an automated computing agent, such as bot 144 running on automated computing agent engine.

Anomalies can be detected by an outlier detection algorithm to discriminate normal data from outliers. Example algorithms can be Peak Over the Threshold (POT), Grubb's Test (also called extreme studentized deviate test, ESD), Isolation Forest, One-Class SVM, etc. These flags can be logged in databases 228-1 and 228-r for future reference or used to trigger additional actions, such as further verification steps or the denial of access to content delivery engines 104.

Generally an anomaly will be detected only if the timing data exceeds a threshold value, due to extra time introduced by the automated computing agent engine 140. In other words, while the CAPTCHA was solved, it was solved “too slowly”, making it anomalous to expected behaviour from a client device 116 and therefore suggesting the presence of electronic verification engine 136. However, as automated computing agent engines 140 evolve, the present disclosure contemplates that an anomaly may also be detected if the CAPTCHA was solved “too quickly”, making it anomalous to expected behaviour from a client devices 116 and therefore suggesting the presence of electronic verification engine 136.

The electronic verification engine 136 can host a variety of electronic verification systems, including Completely Automated Public Turing test to tell Computers and Humans Apart (CAPTCHA). In this configuration, the automated computing agent engine 140 is configured to attempt to solve CAPTCHA challenges by simulating human interaction patterns. The bypass detection engine 120 is capable of identifying automated solvers that can bypass CAPTCHAs by analyzing timing data associated with the interaction between the requesting node and the verification system.

The timing data monitored by the bypass detection engine 120 can include, but is not limited to, propagation times associated with the communication between the requesting node and the electronic verification engine 136. For instance, a site key propagation time can be measured between the transmission of a site key from the requesting node (e.g. a client device 116 or automated computing agent engine 140) to the electronic verification engine 136, and the receipt of a signal by the electronic verification engine 136 indicating that the requesting node has attempted to interact with the electronic verification system. For instance, a site key propagation time can be measured between: the transmission of a site key from a content delivery engine 104 to a requesting node (such as a client device 116 or automated computing agent engine 140); the transmission of the same key to the electronic verification engine 136; and the receipt of a signal by the electronic verification engine 136, collectively indicating that the requesting node has attempted to interact with the electronic verification engine 136. In addition to the site key propagation time, the timing data may further comprise a token propagation time. The token propagation time is measured between the transmission of a token from the electronic verification engine 136 to the requesting node and the receipt of that token by the content delivery engine 104 from the requesting node. By comparing both site key and token propagation times, the system can assess the reliability of the measurements; similar times suggest stable measurements, whereas significant discrepancies may indicate network delays affecting one of the measurements. In cases of discrepancy, the shorter propagation time may be selected as it is closer to real-time. This selected time is then compared to predefined thresholds and historical data to determine whether the interaction might involve an automated solver,

In some embodiments, the bypass detection engine 120 may also identify whether the requesting node is utilizing a Virtual Private Network (VPN) based on network data associated with the requesting node. If VPN usage is detected, the expected range for timing data may be adjusted to account for the typically longer latency times introduced by the VPN. Whitelisting known VPN IP addresses can also streamline identification of VPNs. This adjustment ensures that the comparison between actual and expected propagation times remains accurate.

The bypass detection engine 120 is further capable of retrieving statistical information regarding average propagation times based on the geographic locations of the requesting node, content delivery engine 104, and electronic verification engine 136. This information allows the system to establish baseline expected propagation times, which are geographically dependent.

The bypass detection engine 120 can apply extreme value theory (EVT), instead of machine learning, to identify outliers in the observed timing data. For example, peaks-over-threshold analysis can be used to set appropriate thresholds for determining the expected range of timing data, ensuring that unusual or anomalous values are flagged for further investigation.

In some configurations, the bypass detection engine 120 employs machine learning models trained on historical timing data to detect anomalies. These models can be used to identify patterns in the timing data that suggest the presence of automated computing agents. The machine learning model could utilize various techniques, including unsupervised learning algorithms, to classify interactions as human or automated based on historical interaction patterns.

A presently preferred machine learning model for identifying anomalies is the isolation forest algorithm. This model isolates potential automated computing agent behavior by distinguishing it from normal requesting node behavior. By identifying deviations in timing patterns, the isolation forest algorithm helps the bypass detection engine 120 detect the presence of automated solvers attempting to bypass electronic verification.

To refine the expected range for timing data, delay-based internet protocol (IP) geolocation techniques can be employed. These techniques estimate the geographic distance between the requesting node, content delivery engine 104, and electronic verification engine 136 by calculating network delays. This can enable the bypass detection engine 120 to set more precise timing expectations based on the physical locations of the involved parties.

In addition to considering geographic factors, the bypass detection engine 120 can adjust the expected range for timing data based on historical network performance data for the geographic region of the requesting node. For example, if the network in a particular region is known to experience congestion at certain times, the system can adapt its expected timing ranges accordingly to prevent false positives.

In some embodiments, the bypass detection engine 120 identifies anomalies by comparing both the site key propagation time and the token propagation time. The system may utilize the smaller of the two propagation times to make its determination, thus ensuring that minor network delays in one type of communication do not falsely trigger an anomaly.

To further improve accuracy, the bypass detection engine 120 can synchronize the clocks of the electronic verification engine 136 and the content delivery engine 104. This can assist in consistency of the timing data measurements reduce discrepancies caused by unsynchronized clocks, allowing the system to compare expected and actual propagation times.

The content delivery engines 104, as described, have primarily been outlined in relation to hosting websites. However, it is understood that the content being delivered could extend beyond traditional web-based content to include distributed applications, microservices, Internet of Things (IoT) devices, or even blockchain-based platforms. In each case, the timing data monitored by bypass detection engine 120 could differ depending on the type of content being requested and the architecture of the system.

A person of skill in the art will now appreciate that there are many ways method 400 can be implemented. However, a presently preferred example in the form of pseudocode is presented below to further illustrate how method 400 can be realized:

propagationTimeSiteKey ← stopTimeSiteKey − startTimeSiteKey
propagationTimeToken ← stopTimeToken − startTimeToken
targetTime ← min(propagationTimeSiteKey,
propagationTimeToken)
threshold ← PeaksOverThreshold(historicalData[locationWebsite,
locationClient, locationCaptchaService])
if targetTime > threshold then
raise alert “Abnormal Behavior”

To explain the foregoing in the context of system 100 and method 400, here are the Inputs:

```
    locationWebsite: Geolocation of the website server
i. (e.g., Content delivery engine 104)
    locationClient: Geolocation of the client/user device
i. (e.g., Client device 116 or automated computing agent engine 140)
    locationCaptchaService: Geolocation of the CAPTCHA service
i. (e.g., Electronic verification engine 136)
    startTimeSiteKey: Timestamp when the site key was sent
    stopTimeSiteKey: Timestamp when the site key was received
    startTimeToken: Timestamp when the CAPTCHA token was sent
    stopTimeToken: Timestamp when the CAPTCHA token was received
    historicalData: Dataset of network propagation times for comparison
    Method Blocks:
    Block 404: Calculate the propagation time for the site key:
  propagationTimeSiteKey ← stopTimeSiteKey − startTimeSiteKey
    Block 404: Calculate the propagation time for the token:
  propagationTimeToken ← stopTimeToken − startTimeToken
    Block 408: Determine the target propagation time:
  targetTime ← min(propagationTimeSiteKey, propagationTimeToken)
    Block 408: Calculate the anomaly threshold:
  threshold + PeaksOverThreshold(historicalData[locationWebsite, locationClient,
locationCaptchaService])
    Block 412: Compare the target propagation time with the threshold:
    Block 416: if targetTime > threshold then
      a. Block 424:
      b. raise alert “Anomaly Detected”
      c. end if
    (Note: Block 420 is implicit as the lack of an anomaly ensures that Block
416 evaluates to false.)
```

For further reading, one is directed to Coles, S. (2001). An Introduction to Statistical Modeling of Extreme Values, the contents of which are incorporated herein by reference, discusses Extreme Value Theory and the concept of Peaks Over Threshold.

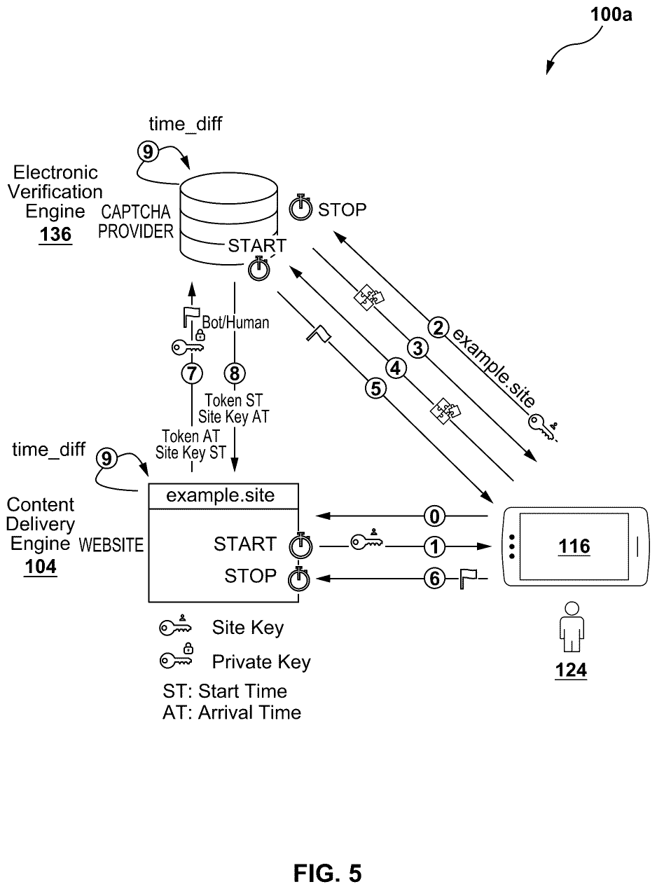

FIG. 5 shows another embodiment, indicated as system 100a, which is a variant of system 100. For illustrative simplicity, client device 116 and automated computing agent engine 140 are omitted from the diagrams, but a skilled reader will appreciate how they are included with system 100a, in that the user 124 interaction shown in FIG. 5 is via client device 116. FIG. 5 represents the “normal” or “anomaly-free” interaction which is flagged by the bypass detection engine 120, as such, meaning that bypass detection engine 120 does not detect an anomaly and reaches a “yes” determination at block 416 so that method 400 advances to block 420.

Furthermore, in the embodiment of FIG. 5, note that bypass detection engine 120 may either be integrated within content delivery engine 104 or operate as a separate component interfacing with content delivery engine 104 and electronic verification engine 136 as per FIG. 1. Either configuration is contemplated, and thus bypass detection engine 120 is not expressly shown in system 100a. In either case, the system 100a, including bypass detection engine 120 in whatever form, performs timing-based anomaly detection, comparing site_key_propagation_time and token_propagation_time to identify interactions that align with typical user activity versus bot behavior. This adaptable architecture supports different implementation models based on specific application needs.

Accordingly, FIG. 5 illustrates system 100a in the context of a valid, non-anomalous user interaction, which may include both pre-verified users 124/client devices 116 (whitelisted) and users 124/client devices 116 undergoing standard CAPTCHA verification. This embodiment demonstrates a direct and predictable verification process for a typical user, without any anomaly detected at bypass detection engine 120.
Step (0) User 124, operating client device 116, initiates a request for a webpage from content delivery engine 104 (e.g., www.example.site). This request triggers a verification sequence by content delivery engine 104.
Step (1) Upon receiving the webpage request, content delivery engine 104 determines that verification with electronic verification engine 136 is required to permit access. Consequently, content delivery engine 104 sends a site_key to client device 116, instructing it to use the site_key to engage with electronic verification engine 136.
Step (2) Client device 116 transmits the site_key to electronic verification engine 136, along with the URL or IP address of content delivery engine 104, to initiate the verification process.
Step (3) For users 124 who are not pre-verified, electronic verification engine 136 issues a CAPTCHA challenge to client device 116 as part of the standard verification sequence. Step (4) Client device 116 returns the completed CAPTCHA solution to electronic verification engine 136 upon solving it.
Step (5) Upon verification of either the CAPTCHA solution or the pre-verified status, electronic verification engine 136 generates a unique token and sends it to client device 116 as confirmation.
Step (6) Client device 116 then forwards this token to content delivery engine 104 to fulfill the verification requirement established by content delivery engine 104.
Step (7) To authenticate the token, content delivery engine 104 uses a private key to relay the token back to electronic verification engine 136, seeking confirmation of its authenticity.
Step (8) Electronic verification engine 136 confirms that the token represents typical user activity, enabling content delivery engine 104 to grant access without flagging any anomalies.

The bypass detection engine 120 of system 100a further enhances verification reliability by measuring and analyzing propagation times of key transmissions between content delivery engine 104 and electronic verification engine 136. These propagation times are used to verify the authenticity of the interaction and detect potential automation.

In step (1), content delivery engine 104 shares the site_key with client device 116, which is subsequently transmitted to electronic verification engine 136 in step (2). By consulting application logs at both content delivery engine 104 and electronic verification engine 136, the system captures the timestamps for when the site_key was sent and received. The difference in time between these two events defines the site_key_propagation_time.

In step (5), after successfully completing CAPTCHA verification (or bypassing it, if pre-verified), electronic verification engine 136 issues a unique token to client device 116. In step (6), client device 116 submits this token back to content delivery engine 104. The timestamps recorded at both ends enable calculation of the token_propagation_time, representing the interval from token issuance at electronic verification engine 136 to token reception at content delivery engine 104.

Additionally, the propagation times can be shared and validated between content delivery engine 104 and electronic verification engine 136 to increase detection accuracy. In step (7), content delivery engine 104 may share the token arrival time and the site_key issuance time with electronic verification engine 136 for corroboration. Conversely, in step (8), electronic verification engine 136 may share its corresponding site_key arrival time and token issuance time back to content delivery engine 104.

In an additional check at step (9), both content delivery engine 104 and electronic verification engine 136 compute and compare the site_key_propagation_time and token_propagation_time. Ideally, these propagation times should align within expected ranges, accounting for known network latency factors, geographic locations, and the IP address of client device 116. If discrepancies arise (e.g., an unusually short or long propagation time), the system may flag the interaction as suspicious and assess it further for potential bot activity.

To enhance reliability, the bypass detection engine 120 may conduct supplementary statistical analyses on these metrics across numerous connections to establish baseline ranges for typical user interactions. This comparison enables adaptive, data-driven detection of anomalies that may indicate automated CAPTCHA-solving attempts.

The propagation time checks can be executed by both content delivery engine 104 and electronic verification engine 136 independently, or they may exchange information as in steps (7) and (8) for cross-verification. Shared data might include not only timestamps but also additional contextual data, such as geographic location, registered IP address, and historical interaction patterns, enhancing the robustness of bot detection mechanisms.

The bypass detection engine 120 correlates interactions based on the unique token associated with each CAPTCHA session, allowing it to track and validate each verification instance uniquely.

To further increase the accuracy of the measurement, the bypass detection engine 120 could consider issuing multiple CAPTCHA challenges in sequence, comparing each propagation time to verify consistency. However, this approach may negatively impact user experience and should be implemented selectively.

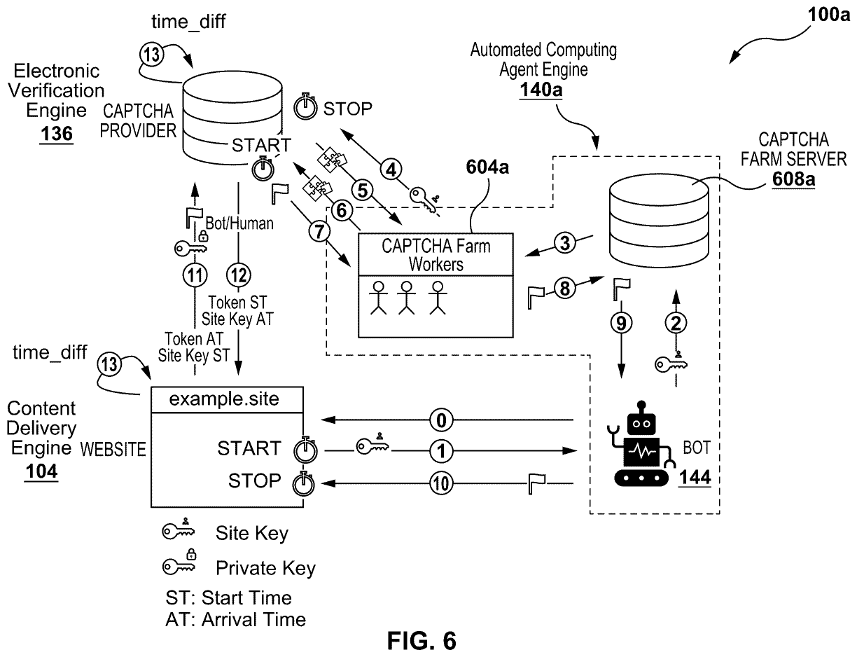

FIG. 6 illustrates another embodiment within system 100a, focusing specifically on detecting automated bot interactions that utilize CAPTCHA farm workers 604a. In this scenario, bot 144, operating through automated computing agent engine 140a, initiates a request to access content delivery engine 104. (For clarity, FIG. 6 does not include user 124 or client device 116, as FIG. 6 is tailored to highlight the interaction with CAPTCHA farm workers 604a and the decision process leading to a “No” determination at block 416 directing the method flow to block 424.)

The following steps describe the sequence of information exchange as depicted in FIG. 6, where the bot-driven request leverages CAPTCHA farm workers 604a to bypass verification controls at electronic verification engine 136:
Step (0): Bot 144 initiates a request for a webpage from content delivery engine 104 (e.g., example.site), beginning the verification sequence within system 100a.
Step (1): Content delivery engine 104, upon recognizing a need for verification, transmits a site_key to bot 144, instructing it to interact with electronic verification engine 136. This step mimics the standard procedure of initiating a CAPTCHA verification process.
Step (2): Instead of directly contacting electronic verification engine 136, bot 144 forwards the site_key to CAPTCHA farm server 608a, a component of automated computing agent engine 140a, along with the URL or IP address of content delivery engine 104.
Step (3): CAPTCHA farm server 608a assigns the CAPTCHA-solving task to a worker within CAPTCHA farm workers 604a. CAPTCHA farm server 608a transmits the site_key and the URL to the selected worker.
Step (4): The assigned CAPTCHA farm worker within 604a uses the site_key to contact electronic verification engine 136, submitting the site_key along with the URL or IP address of content delivery engine 104 to initiate the CAPTCHA challenge.
Step (5): Optionally, based on preliminary analysis of the worker's information (e.g., IP address), electronic verification engine 136 may decide not to issue a CAPTCHA test if it concludes the worker's connection likely originates from a proper user 124 operating client device 116. However, in the normal course, automated computing agent engine 140a would not pass such a preliminary analysis, and thus, electronic verification engine 136 issues a CAPTCHA test.
Step (6): If a CAPTCHA test is issued, the CAPTCHA farm worker in the pool of CAPTCHA farm workers 604a attempts to solve it and sends the solution back to electronic verification engine 136.
Step (7): Upon successfully receiving and validating the CAPTCHA solution, or if no CAPTCHA challenge was issued, electronic verification engine 136 generates a unique token associated with the interaction and sends it to the respective CAPTCHA farm worker within 604a.
Step (8): The CAPTCHA farm worker transmits the unique token back to CAPTCHA farm server 608a.
Step (9): CAPTCHA farm server 608a relays the unique token to bot 144, enabling bot 144 to proceed with the verification requirements.
Step (10): Bot 144 then forwards the unique token to content delivery engine 104 to fulfill the verification prerequisite established by content delivery engine 104.
Step (11): To validate the token, content delivery engine 104 uses a private key to transmit the token back to electronic verification engine 136, seeking confirmation of its authenticity.
Step (12): Electronic verification engine 136 assesses the token and, based on timing and interaction data, determines whether the request aligns with typical user activity or, as per FIG. 6, is indicative of bot 44 behavior. Due to the additional delays introduced by the CAPTCHA farm server 608a and CAPTCHA farm workers 604a, electronic verification engine 136 identifies this interaction as anomalous, associating it with bot activity and providing a “No” determination at block 416.
Step (13): The time_diff calculations for START and STOP are logged for each interaction, providing a record of both successful and failed verification attempts.

The anomaly detection within bypass detection engine 120 relies on the measured propagation times of the site_key and token transmissions. By examining timestamps from both content delivery engine 104 and electronic verification engine 136, bypass detection engine 120 calculates site_key_propagation_time and token_propagation_time. These times are compared against expected ranges based on legitimate user activity as per FIG. 5, allowing system 100a to detect inconsistencies associated with CAPTCHA farm usage. The bypass detection engine 120 leverages statistical analysis and correlation techniques, potentially consulting external databases to assess network conditions or IP address characteristics that may further refine bot detection accuracy.

In cases of discrepancy, where propagation times exceed expected thresholds or otherwise align with known CAPTCHA farm characteristics, bypass detection engine 120 classifies the interaction as bot 44 activity, as per block 424. This classification then directs system 100a to block access to the content delivery engine 104, ensuring enhanced security against automated CAPTCHA-solving attempts.

In some variants, CAPTCHA farms may employ a pipeline process whereby multiple CAPTCHA tests (x tests) are requested by a bot in a single submission to the CAPTCHA server. In such cases, the site_key propagation_time is only measured for the first request in the batch, while the subsequent x−1 requests yield only token_propagation_time measurements. The bypass detection engine 120 can therefore operate using the available token_propagation_time alone. The absence of site_key propagation_time for such requests can itself be treated as an indicator of CAPTCHA farm activity and incorporated into the anomaly determination.

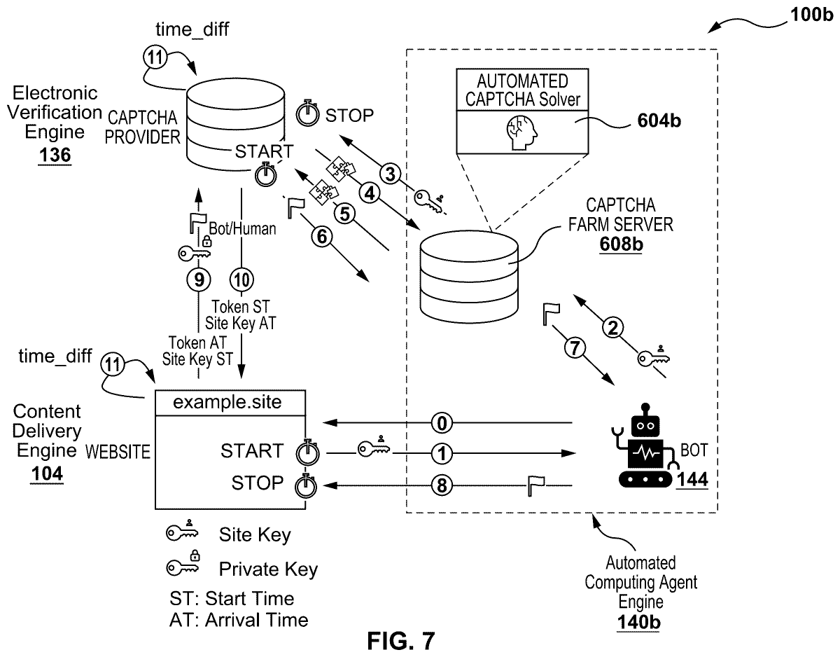

FIG. 7 illustrates another as system 100b, which is a variant of system 100a from FIG. 6. In this embodiment, bot 144 utilizes a CAPTCHA-solving engine 604b, which could be AI-powered, perhaps trained via CAPTCHA farm workers 604a, within automated computing agent engine 140b to access content delivery engine 104 via bot 144. In contrast to FIG. 6, where CAPTCHA Farm workers 604a are involved, system 100b of FIG. 7 features automated processes within CAPTCHA-solving engine 604b.

This configuration highlights an interaction where bot 144 relies on CAPTCHA-solving engine 604b rather than human CAPTCHA workers 604a to bypass the CAPTCHA verification process in electronic verification engine 136. Here, the CAPTCHA-solving engine 604b operates more efficiently than human-driven CAPTCHA farm workers 604a potentially achieving faster response times due to the absence of human latency. However, this setup still introduces delays that are detectable by comparing the site_key and token propagation times, as explained below.

### Steps for System 100b in FIG. 7:

Step (0) Bot 144 initiates a request for a webpage from content delivery engine 104 (e.g., www.example.site), prompting the CAPTCHA verification sequence.
Step (1) Upon receiving this request, content delivery engine 104 requires CAPTCHA verification to allow access to the requested resource. Therefore, it sends a site_key to bot 144, instructing it to interact with electronic verification engine 136 for CAPTCHA verification.
Step (2) Bot 144, via automated computing agent engine 140b, forwards the site_key to the CAPTCHA-solving engine 604b via CAPTCHA Farm server 608b, along with the URL or IP address of content delivery engine 104.
Step (3) The CAPTCHA-solving engine 604b directly submits the site_key to electronic verification engine 136, bypassing human involvement and, consequently, possibly reducing latency compared to human CAPTCHA workers of CAPTCHA farm workers 604a.
Step (4) Optionally, the CAPTCHA service may choose not to issue a CAPTCHA test if initial information (such as IP address) suggests a definitive classification of the connection as user 124 or bot 144 traffic. If the AI CAPTCHA Solver's data does not trigger any alerts, it can proceed without a CAPTCHA challenge.
Step (5) If a CAPTCHA test is issued, the AI CAPTCHA Solver submits a solution back to electronic verification engine 136.
Step (6) Upon successful completion of the CAPTCHA, electronic verification engine 136 sends a unique token back to the CAPTCHA-solving engine 604b.
Step (7) The CAPTCHA-solving engine 604b relays this token to CAPTCHA Farm server 608b.
Step (8) CAPTCHA Farm server 608b transmits the token to bot 144.
Step (9) Bot 144 then sends the token to content delivery engine 104 to meet the verification requirement.
Step (10) To verify the token's authenticity, content delivery engine 104 uses a private key to relay the token back to electronic verification engine 136.
Step (11) Electronic verification engine 136 analyzes the token and informs content delivery engine 104 whether the token indicates typical user activity or suspicious bot activity. Given that AI-based CAPTCHA solvers can introduce unique timing signatures, the bypass detection engine 120 may detect inconsistencies based on a timing analysis of site_key and token propagation times, differentiating this setup from legitimate user behavior.

In another variant, an automated computing agent may solve a CAPTCHA even before the corresponding page request is issued to the website, having obtained the site key and target URL in advance. In this case, the measured site_key propagation_time can become negative—because the CAPTCHA server receives the site key before the website sends it. When a negative site_key propagation_time is detected, the bypass detection engine 120 can flag the request directly as malicious. In such instances, the token_propagation_time remains a reliable indicator and can be used independently for anomaly detection.

While the embodiments have been described in the context of a centralized bypass detection engine 120, variants could include a decentralized or distributed model. In such a configuration, each content delivery engine 104 could be equipped with a lightweight detection module (e.g. executing a portion of method 400), communicating anomalies back to a central coordinating engine (either bypass detection engine 120 or an equivalent thereof). Thusly, in certain variants bypass detection engine 120 can be incorporated directly into content delivery engines 104. Such a distributed setup can help reduce load of network 108 by performing some anomaly detection locally, particularly useful in systems with high traffic volumes.

It will also be understood that while the system 100 has been described in terms of detecting automated agents attempting to bypass electronic verification engines, other applications for anomaly detection are also possible. For example, bypass detection engine 120 could be used in systems where transactional integrity is an aspect, such as in financial platforms or stock trading systems. In such cases, the timing data can be used to detect anomalous transaction times or fraud attempts, enabling real-time alerts and system interventions.

Although propagation time has been emphasized as the primary form of timing data, other types of timing measurements are contemplated. For example, the system could monitor round-trip times (RTT) for various network requests, latency in server response times, or even variations in processor cycle timings. Each of these timing measurements could provide additional granularity in detecting anomalies, particularly in systems that handle sensitive or time-critical transactions.

In some embodiments, the system 100 can further integrate third-party geolocation services to refine the geographic-based analysis of propagation times. For example, external geolocation application programming interfaces (APIs) can provide more accurate data on the requesting node's location, enhancing the precision of the expected range calculation.

Although the focus of the embodiments has been on comparing timing data against expected ranges derived from geographic and network data, additional contextual data could also be factored in. For example, historical usage patterns of the requesting node, user profile information, or even device-specific data (e.g., type of client devices 116, or operating system executing thereon) could be included in determining whether an anomaly exists. This can help refine anomaly detection by accounting for normal variations in behavior that are specific to individual users or devices.

In another variant, the bypass detection engine 120 may be extended to detect anomalies in cross-system interactions. For example, in systems where content delivery engines 104 operate in tandem with external third-party services (e.g., cloud storage or content distribution networks), the bypass detection engine 120 can monitor timing data not only within the local system 100 but also across external interactions. This can allow for more comprehensive anomaly detection, particularly in hybrid cloud environments.

While the described embodiments have used the bypass detection engine 120 for flagging potential automated agents, it is also contemplated that the system could incorporate additional remediation measures. For instance, upon detecting an anomaly, the system 100 can be configured to dynamically adjust the verification challenge, increasing the complexity of the CAPTCHA test, adding multi-factor authentication steps, or throttling the interaction speed to further challenge potential bots. This dynamic adjustment could be based on the severity of the anomaly, as determined by the bypass detection engine 120.

Another variant includes integration with distributed ledger or blockchain systems. The bypass detection engine 120 could be configured to validate interactions within blockchain-based systems, ensuring that transaction times are consistent with expected ranges based on geographic or network data. This could prevent automated systems or malicious actors from attempting to overwhelm the blockchain with rapid, repeated transaction requests.

Additionally, the system 100 can employ techniques such as packet inspection to further refine anomaly detection at block 412. By analyzing the content of network packets, the bypass detection engine 120 can gain insights into the types of requests being made and their consistency with typical user behavior. For example, repeated requests for sensitive content in a short time frame could be flagged as suspicious, even if the timing data falls within normal ranges.

Additionally, the bypass detection engine 120 can be configured to integrate real-time packet flow analysis alongside timing data. By correlating packet-level inspection with observed timing anomalies, the system could further refine the accuracy of detecting automated agents. For example, network traffic associated with automated solvers can exhibit distinctive packet patterns, such as unusual packet size distributions, repetitive data flows, or specific packet header manipulations that diverge from typical human user behavior. By analyzing these patterns in conjunction with timing discrepancies, the system could improve its ability to differentiate between legitimate and automated traffic, even in cases where automated solvers attempt to mimic human interaction.

Furthermore, the system can implement behavioral analysis models that track interaction sequences across multiple content delivery engines 104 over time. This temporal tracking can help detect long-term automation strategies, such as distributed botnets attempting to avoid detection by spreading requests across different nodes in the system 100. (i.e. detecting a plurality of automated computing agent engines 140 working in tandem). By observing behavioral deviations over a defined period, the system can identify anomalies in interaction patterns, such as excessively rapid navigation through multiple verification checkpoints or inconsistent time intervals between actions.

In another embodiment, the bypass detection engine 120 may incorporate heuristic algorithms capable of detecting low-frequency attacks. For instance, certain automated computing agents might intentionally reduce the frequency of their requests to avoid triggering real-time detection mechanisms. By employing heuristic techniques that evaluate interaction patterns over extended periods, the system could detect these low-frequency automated attempts, which would otherwise evade traditional anomaly detection based on immediate timing data.

The system 100 can also be extended to monitor interactions in encrypted communication channels. By analyzing metadata, such as encrypted packet lengths, transmission intervals, and traffic volume, the system could detect suspicious patterns without decrypting the content itself. Such methods could allow the detection of automated computing agents even in scenarios where end-to-end encryption prevents direct packet content analysis.

In certain embodiments, the system 100 can utilize crowdsourcing techniques to enhance its anomaly detection capabilities. For example, real-world data collected from multiple independent systems can be aggregated and analyzed to build a more robust model of typical user behavior across different regions and networks. By leveraging a large, decentralized dataset, the system could improve its sensitivity to both localized and globalized anomalies, identifying automation attempts that span across various content delivery engines and verification platforms.

To address advanced threats, such as adversarial machine learning (ML) attacks, where automated agents use sophisticated algorithms to bypass detection, the bypass detection engine 120 may employ counter-adversarial techniques. This can include continuously retraining ML models using live data to adapt to evolving attack strategies. Additionally, the system could introduce randomization in its challenge-response mechanisms (e.g., CAPTCHA variations) to reduce the predictability of the verification process, thereby increasing the difficulty for automated agents attempting to use pre-trained models to solve challenges.

Another variant of the system 100 can incorporate biometric authentication data, such as keystroke dynamics, mouse movement patterns, or touch interaction data from mobile devices. These biometric features can be used in tandem with timing data to assess the legitimacy of the requesting node's behavior. For example, even if the timing data appears normal, discrepancies in biometric interaction patterns—such as unnaturally smooth or repetitive mouse movements—could trigger the system to flag the interaction as suspicious.

Additionally, the system 100 can be designed to interact with fraud detection engines used in financial systems or e-commerce platforms. By correlating transaction timing anomalies with behavioral patterns detected in the verification process, the system could provide a more comprehensive approach to identifying fraudulent activity. For instance, rapid, repeated purchases or login attempts from different geographic locations could be flagged as part of a coordinated bot attack, even if individual timing data for each transaction appears legitimate.

In another embodiment, the system 100 can integrate with Distributed Denial of Service (DDoS) mitigation services. The bypass detection engine 120 can monitor traffic patterns and detect coordinated botnet attacks aimed at overwhelming the verification system with automated requests. By identifying the source of these attacks through timing analysis and packet inspection, the system could trigger countermeasures, such as traffic throttling, blacklisting IP ranges, or diverting traffic through scrubbing centers.

As discussed above, it is to be understood that one or more of the applications can include a machine learning studio platform with any desired related machine learning (ML) based algorithms and/or statistics which can be preferred to a deep learning approach. The machine learning applications can utilize various algorithms, instead of or in addition to isolation forest, including but not limited to: DBSCAN, One-Class Support Vector Machine, Local Outlier Factor, Gaussian Mixture Models, Grubb's test, Peaks Over the Threshold.

A person skilled in the art will appreciate that the present specification offers certain technical advantages over the prior art. For example bypass detection engine 120 (and associated methods, and variants) offers enhanced detection accuracy, achieved through a combination of one or more of timing data analysis, machine learning algorithms, and statistical methods such as extreme value theory. This can identify anomalies with improved precision compared to traditional methods. Additionally, the architecture is designed for scalability, allowing for deployment across multiple geographic regions. By enabling distributed anomaly detection, it can reduce latency and effectively handles high-traffic environments.

Another advantage of this specification is the ability to dynamically adjust timing thresholds based on factors such as VPN usage, historical network performance, and geolocation. This adaptability accommodates varying network conditions as compared to the prior art. Furthermore, advanced machine learning models, such as isolation forests, can be integrated to detect novel attack patterns, making the system adaptable to evolving threats. These models, when combined with contextual data—such as geographic location, historical usage patterns, and biometric interactions—can reduce false positive rates and enhance detection capabilities.

It is to be reiterated that features and aspects of the various examples provided above can be combined into further examples that also fall within the scope of the present disclosure. In addition, the figures are not to scale and can have size and shape exaggerated for illustrative purposes.

1. A computer-implemented method for detecting automated computing agents attempting to bypass an electronic verification system, the method including instructions executed by a bypass detection engine, comprising:
receiving, at the bypass detection engine, timing data associated with communication between a requesting node and at least one of a content delivery engine and an electronic verification engine;
determining, at the bypass detection engine, an expected range for the timing data based on at least one of the geographic locations of the requesting node, the content delivery engine, and the electronic verification engine;
comparing the timing data with the determined range;
identifying an anomaly if the timing data is outside the expected range; and
flagging the requesting node as an automated computing agent based on identification of the anomaly; and,
otherwise, flagging the requesting node as a client device.

2. The method of claim 1, wherein the electronic verification engine hosts a Completely Automated Public Turing test to tell Computers and Humans Apart (CAPTCHA) and the automated computing agent is an automated solver for CAPTCHAs.

3. The method of claim 1, wherein the timing data comprises:
a site key propagation time, measured between: (i) the transmission of a site key from the content delivery engine to the requesting node; (ii) the transmission of the same key to the electronic verification engine; and (iii) the receipt of a signal by the electronic verification engine indicating an attempt by the requesting node to interact with the electronic verification system.

4. The method of claim 1, wherein the timing data further comprises:
a token propagation time, measured between the transmission of a token from the electronic verification engine to the requesting node and the receipt of the token by the content delivery engine from the requesting node.

5. The method of claim 1, further comprising:
identifying whether the requesting node is utilizing a Virtual Private Network (VPN) based on network data associated with the requesting node, and
adjusting the expected range for the timing data based on the identification of VPN usage.

6. The method of claim 1, wherein determining the expected range for the timing data further comprises:
retrieving statistical information on average propagation times based on the geographic locations of the requesting node, the content delivery engine, and the electronic verification engine.

7. The method of claim 1, wherein determining the expected range for the timing data further comprises:
applying extreme value theory to identify outliers in the observed timing data, setting the range based on peaks over threshold analysis.

8. The method of claim 1, further comprising:
detecting anomalies in the timing data by utilizing a machine learning model trained on historical timing data, wherein the model identifies timing anomalies indicative of automated computing agents.

9. The method of claim 8, wherein the machine learning model comprises:
an isolation forest algorithm configured to identify anomalies by isolating potential automated computing agent behavior from normal requesting node behavior.

10. The method of claim 1, wherein determining the expected range for the timing data further comprises:
calculating the range using delay-based IP geolocation techniques to estimate geographic distances based on network delay measurements.

11. The method of claim 1 further comprising:
adjusting the expected range for the timing data based on historical network performance data for the geographic region of the requesting node.

12. The method of claim 1, wherein identifying an anomaly further comprises:
comparing both the site key propagation time and the token propagation time to determine the more reliable measurement, selecting the shorter of the two times, and using this selected time to compare against a threshold value calculated based on geolocation, machine learning models, or other techniques to identify an anomaly.

13. The method of claim 1, further comprising:
synchronizing the clocks of the electronic verification engine and the content delivery engine to ensure accuracy in the timing data measurements.

14. The method of claim 1, wherein the timing data comprises a site key propagation time for a first request and only a token propagation time for one or more subsequent requests, wherein the identifying of the anomaly further includes identifying the anomaly when the site key propagation time is absent for the subsequent requests.

15. The method of claim 1, wherein the identifying of the anomaly further comprises identifying the anomaly when a site key propagation time is negative.

16. A bypass detection server including a processor and a memory, the memory for storing a plurality of programming instructions configured according to the method of claim 1.

17. A computer-readable medium including programming instructions executable by a processor according to the method of claim 1.
